(19) United States
(12) Patent Application Publication
(10) Pub. No.: US 2023/0348810 A1
(43) Pub. Date: Nov. 2, 2023

(54) WATER-SOLUBLE METALWORKING FLUID

(71) Applicant: IDEMITSU KOSAN CO.,LTD., Tokyo (JP)

(72) Inventors: Tomoaki OKANO, Tokyo (JP); Keiji ASADA, Tokyo (JP)

(73) Assignee: IDEMITSU KOSAN CO.,LTD., Tokyo (JP)

(21) Appl. No.: 18/007,151

(22) PCT Filed: Jul. 9, 2021
(86) PCT No.: PCT/JP2021/025920

§ 371 Date: Jan. 27, 2023

(30) Foreign Application Priority Data
Jul. 30, 2020 (JP) 2020-129212

(51) Int. Cl. C10M 173/00; C10M 169/04; C10M 101/02; C10M 129/16; C10M 135/10; C10M 133/08; C10M 133/10; C10M 141/08; C10M 145/12; C10M 145/36; C10M 161/00

(52) U.S. Cl. CPC C10M 173/00; C10M 169/044; C10M 101/02; C10M 129/16; C10M 135/10; C10M 133/08; C10M 133/10; C10M 141/08; C10M 145/12; C10M 145/36; C10M 161/00; C10M 2201/02; C10M 2203/1025; C10M 2207/046; C10M 2219/044; C10M 2215/26; C10M 2209/082; C10M 2209/108; C10N 2040/243

(57) ABSTRACT

A water-soluble metalworking oil may include 0.7% by mass or more of 2-phenoxyethanol (A), based on the total water-soluble metalworking oil mass. A content of petroleum sulfonate may be less than 10 parts by mass, based on 100 parts by mass of the 2-phenoxyethanol (A). The 2-phenoxyethanol (A) may be present in a range of from 0.7 to less than 5.0% by mass. The water-soluble metalworking oil may further include: an amine, a fatty acid (C), and/or a nonionic surfactant (D).

### TECHNICAL FIELD

The present invention relates to a water-soluble metalworking oil, a metalworking fluid obtained by blending the water-soluble metalworking oil with dilution water, and a metalworking method comprising processing a workpiece comprising metal by application of the metalworking fluid.

### BACKGROUND ART

In the art of metalworking such as cutting and grinding, metalworking fluids are used to increase workability for workpieces and to suppress wear of working tools.

Metalworking fluids include oil-based metalworking fluids containing oils such as mineral oils, synthetic oils, and animal and vegetable oils as main components, and water-soluble metalworking fluids provided with water solubility by blending an oil with a surface-active compound. Recently, water-soluble metalworking fluids are increasingly used for safety reasons such as a reduced risk of catching fire.

For example, Patent Literature 1 discloses a water-soluble working oil containing methyldicyclohexylamine. The water-soluble working oil is diluted with dilution water to provide a metalworking fluid, which is then used in metalworking.

### CITATION LIST

### Patent Literature

### Patent Literature 1

International Publication No. WO 2010/113594

### SUMMARY OF INVENTION

### Technical Problem

While the water-soluble metalworking oil described in Patent Literature 1 primarily has increased decay resistance and workability, there is room for further increasing various characteristics other than these. For example, the demand exists for novel water-soluble metalworking oils that have various improved characteristics so as to be more readily usable in metalworking than conventional metalworking oils.

### Solution to Problem

The present invention provides a water-soluble metalworking oil containing a predetermined amount of 2-phenoxyethanol. Specifically, the present invention provides, for example, the following embodiments [1] to [12]:
[1] A water-soluble metalworking oil comprising 0.7% by mass or more of 2-phenoxyethanol (A) based on the total amount thereof.
[2] The water-soluble metalworking oil according to [1], wherein a content of petroleum sulfonate is less than 10 parts by mass based on 100 parts by mass of the total amount of the component (A).
[3] The water-soluble metalworking oil according to [1] or [2], wherein a content of the component (A) is 0.7% by mass or more and less than 5.0% by mass based on the total amount of the water-soluble metalworking oil.
[4] The water-soluble metalworking oil according to any one of [1] to [3], further comprising an amine compound (B).
[5] The water-soluble metalworking oil according to any one of [1] to [4], further comprising a fatty acid (C).
[6] The water-soluble metalworking oil according to any one of [1] to [5], further comprising a nonionic surfactant (D).
[7] The water-soluble metalworking oil according to any one of [1] to [6], further comprising a base oil (E).
[8] The water-soluble metalworking oil according to any one of [1] to [7], further comprising water (F).
[9] The water-soluble metalworking oil according to any one of [1] to [8], which is an emulsion-type oil classified as A1 as stipulated in JIS K 2241:2017.
[10] The water-soluble metalworking oil according to any one of [1] to [8], which is a soluble-type oil classified as A2 as stipulated in JIS K 2241:2017.
[11] A metalworking fluid obtained by blending the water-soluble metalworking oil according to any one of [1] to
[10] with dilution water.
[12] A metalworking method comprising processing a workpiece comprising metal by application of the metalworking fluid according to [11].

### Advantageous Effects of Invention

The water-soluble metalworking oil of one suitable embodiment of the present invention is excellent in at least one of stock solution stability and the swarf dispersibility of a diluted metalworking fluid, the water-soluble metalworking oil of one more suitable embodiment is excellent in both stock solution stability and swarf dispersibility, and the water-soluble metalworking oil of one even more suitable embodiment is excellent in both stock solution stability and swarf dispersibility and also excellent in workability when formed into a metalworking fluid.

### DESCRIPTION OF EMBODIMENT

Concerning the numerical ranges described herein, the upper limits and the lower limits can be suitably combined. For example, when a numerical range is described as being “preferably 30 to 100, and more preferably 40 to 80”, the range of “30 to 80” and the range of “40 to 100” are also included in the numerical range described herein. Moreover, for example, when a numerical range is described as being “preferably 30 or more and more preferably 40 or more, and preferably 100 or less and more preferably 80 or less”, the range of “30 to 80” and the range of “40 to 100” are also included in the numerical range described herein.

In addition, for example, “60 to 100” as a numerical range described herein means the range of “60 or more and 100 or less”.

Herein, two terms “metalworking oil” and “metalworking fluid” used are distinguished according to the water content.
“Metalworking oil”: the water content is 0 parts by mass or more and 100 parts by mass or less based on 100 parts by mass of the total amount of components excluding water.
“Metalworking fluid”: the water content is more than 100 parts by mass based on 100 parts by mass of the total amount of components excluding water.

The “metalworking oil” is a stock solution of a metalworking fluid before being diluted with dilution water to provide a metalworking fluid, and is in a form suitable for transportation and storage before being used in metalworking. The “metalworking fluid” is what is obtained by adding dilution water to a stock solution of a metalworking oil to dilute the stock solution, and is in a form suitable when used in metalworking.

### [Configuration of Water-Soluble Metalworking Oil]

The water-soluble metalworking oil of the present invention contains 2-phenoxyethanol (A), and may contain a further component other than the component (A).

For example, the water-soluble metalworking oil of one embodiment of the present invention preferably contains one or more selected from an amine compound (B), a fatty acid (C), a nonionic surfactant (D), and mineral oil (E), more preferably contains at least components (B) and (C), even more preferably contains at least components (B), (C), and (D), and yet more preferably contains all components (B) to (E).

The water-soluble metalworking oil of one embodiment of the present invention may contain water (F), and may contain a further component other than the components (A) to (F) as long as the effects of the present invention are not impaired.

By regulating the water content, the water-soluble metalworking oil can be prepared into an emulsion-type oil classified as A1 and a soluble-type oil classified as A2 as stipulated in JIS K 2241:2017.

In the water-soluble metalworking oil of one embodiment of the present invention, the total content of the components (A) to (C) is preferably 5% by mass or more, more preferably 10% by mass or more, even more preferably 15% by mass or more, yet more preferably 20% by mass or more, particularly preferably 25% by mass or more, and, moreover, may be 27% by mass or more, 30% by mass or more, or 32% by mass or more, and may be 100% by mass or less, 95% by mass or less, 90% by mass or less, 80% by mass or less, 70% by mass or less, 60% by mass or less, 55% by mass or less, 50% by mass or less, 47% by mass or less, 45% by mass or less, or 42% by mass or less based on the total amount (100% by mass) of the water-soluble metalworking oil.

In the water-soluble metalworking oil of one embodiment of the present invention, the total content of the components (A) to (D) is preferably 6% by mass or more, more preferably 11% by mass or more, even more preferably 16% by mass or more, yet more preferably 21% by mass or more, particularly preferably 26% by mass or more, and, moreover, may be 28% by mass or more, 31% by mass or more, 33% by mass or more, or 35% by mass or more, and may be 100% by mass or less, 95% by mass or less, 90% by mass or less, 80% by mass or less, 70% by mass or less, 60% by mass or less, 55% by mass or less, 50% by mass or less, 48% by mass or less, 45% by mass or less, or 43% by mass or less based on the total amount (100% by mass) of the water-soluble metalworking oil.

In the water-soluble metalworking oil of one embodiment of the present invention, the total content of the components (A) to (E) is preferably 15% by mass or more, more preferably 25% by mass or more, even more preferably 35% by mass or more, yet more preferably 45% by mass or more, particularly preferably 55% by mass or more, and, moreover, may be 60% by mass or more, 65% by mass or more, 70% by mass or more, or 75% by mass or more, and may be 100% by mass or less, 95% by mass or less, 90% by mass or less, or 85% by mass or less based on the total amount (100% by mass) of the water-soluble metalworking oil.

In the water-soluble metalworking oil of one embodiment of the present invention, the total content of the components (A) to (F) is preferably 30% by mass or more, more preferably 40% by mass or more, even more preferably 50% by mass or more, yet more preferably 60% by mass or more, particularly preferably 70% by mass or more, and, moreover, may be 75% by mass or more, 80% by mass or more, or 85% by mass or more, and may be 100% by mass or less, 99% by mass or less, 98% by mass or less, 95% by mass or less, or 93% by mass or less based on the total amount (100% by mass) of the water-soluble metalworking oil.

In the water-soluble metalworking oil of one embodiment of the present invention, from the viewpoint of providing a water-soluble metalworking oil that has good stock solution stability and is capable of becoming a metalworking fluid having more increased swarf dispersibility and workability, the mass ratio of the content of the component (A) to the content of the component (B) [(A)/(B)] is preferably 0.01 to 1.2, more preferably 0.03 to 1.0, more preferably 0.05 to 0.85, more preferably 0.07 to 0.80, even more preferably 0.10 to 0.70, even more preferably 0.12 to 0.65, yet more preferably 0.14 to 0.60, yet more preferably 0.16 to 0.50, and particularly preferably 0.18 to 0.45.

Moreover, the mass ratio of the content of the component (A) to the content of the component (B) [(A)/(B)] may be 0.20 or more, 0.22 or more, 0.23 or more, 0.24 or more, or 0.25 or more, and may be 0.42 or less, 0.40 or less, 0.38 or less, 0.36 or less, or 0.35 or less.

In the water-soluble metalworking oil of one embodiment of the present invention, from the viewpoint of providing a water-soluble metalworking oil that has good stock solution stability and is capable of becoming a metalworking fluid having more increased swarf dispersibility and workability, the mass ratio of the content of the component (A) to the content of the component (C) [(A)/(C)] is preferably 0.01 to 1.0, more preferably 0.03 to 0.85, more preferably 0.04 to 0.75, more preferably 0.05 to 0.70, more preferably 0.06 to 0.60, even more preferably 0.08 to 0.55, even more preferably 0.10 to 0.50, yet more preferably 0.13 to 0.45, yet more preferably 0.15 to 0.40, and particularly preferably 0.16 to 0.35.

Moreover, the mass ratio of the content of the component (A) to the content of the component (C) [(A)/(C)] may be 0.17 or more, 0.18 or more, 0.19 or more, or 0.20 or more, and may be 0.32 or less, 0.30 or less, 0.28 or less, 0.25 or less, or 0.23 or less.

In the water-soluble metalworking oil of one embodiment of the present invention, from the viewpoint of providing a water-soluble metalworking oil that has good stock solution stability and is capable of becoming a metalworking fluid having more increased swarf dispersibility and workability, the mass ratio of the content of the component (A) to the content of the component (D) [(A)/(D)] is preferably 0.1 to 12.0, more preferably 0.3 to 10.0, more preferably 0.4 to 11.0, more preferably 0.6 to 8.0, even more preferably 0.7 to 7.0, even more preferably 0.8 to 6.0, even more preferably 0.9 to 5.5, yet more preferably 1.1 to 5.0, yet more preferably 1.2 to 4.8, and particularly preferably 1.3 to 4.5.

Moreover, the mass ratio of the content of the component (A) to the content of the component (D) [(A)/(D)] may be 1.4 or more, 1.5 or more, 1.6 or more, or 1.7 or more, and may be 4.2 or less, 4.0 or less, 3.9 or less, 3.8 or less, or 3.7 or less.

In the water-soluble metalworking oil of one embodiment of the present invention, from the viewpoint of providing a water-soluble metalworking oil that has good stock solution stability and is capable of becoming a metalworking fluid having more increased workability, the mass ratio of the content of the component (B) to the content of the component (C) [(B)/(C)] is preferably 0.01 to 5.0, more preferably 0.05 to 4.0, more preferably 0.07 to 3.5, more preferably 0.1 to 3.0, even more preferably 0.2 to 2.5, even more preferably 0.3 to 2.0, yet more preferably 0.4 to 1.8, and particularly preferably 0.5 to 1.5.

Moreover, the mass ratio of the content of the component (B) to the content of the component (C) [(B)/(C)] may be 0.55 or more, 0.60 or more, 0.65 or more, or 0.70 or more, and may be 1.4 or less, 1.3 or less, 1.2 or less, 1.1 or less, 1.0 or less, or 0.9 or less.

Below, the respective components contained in the water-soluble metalworking oil of one embodiment of the present invention will now be described.

### <Component (A): 2-Phenoxyethanol>

The water-soluble metalworking oil of the present invention contains 0.7% by mass or more of 2-phenoxyethanol (A) based on the total amount thereof.

According to the research conducted by the present inventors, it was found that, by containing 0.7% by mass or more component (A) based on the total amount, gelation of the oil can be effectively suppressed, and a water-soluble metalworking oil having increased stock solution stability can be attained. The metalworking fluid obtained by blending the water-soluble metalworking oil with dilution water, even when allowing a dust of metal swarf produced during metalworking to be present therein, can effectively suppress aggregation of the dust of swarf, and can exhibit excellent swarf dispersibility. Also, workability for a metal material can be increased.

That is to say, by containing 0.7% by mass or more component (A) based on the total amount, the water-soluble metalworking oil of the present invention has excellent stock solution stability and, also, can be prepared into a metalworking fluid capable of having more increased swarf dispersibility and workability.

From the above viewpoint, in the water-soluble metalworking oil of the present invention, the content of the component (A) is 0.7% by mass or more based on the total amount (100% by mass) of the water-soluble metalworking oil, and from the viewpoint of providing a water-soluble metalworking oil capable of having better stock solution stability, and more increased swarf dispersibility and metal workability when formed into a metalworking fluid, the content is preferably 0.9% by mass or more, more preferably 1.0% by mass or more, more preferably 1.2% by mass or more, more preferably 1.6% by mass or more, even more preferably 1.8% by mass or more, even more preferably 2.1% by mass or more, yet more preferably 2.4% by mass or more, yet more preferably 2.6% by mass or more, and particularly preferably 2.8% by mass or more, and from the viewpoint of providing a water-soluble metalworking oil having good low-temperature storability and low-temperature flowability, the content of the component (A) in the water-soluble metalworking oil of the present invention is preferably less than 10% by mass, more preferably less than 7% by mass, more preferably less than 5% by mass, more preferably 4.8% by mass or less, even more preferably 4.5% by mass or less, yet more preferably 4.2% by mass or less, and particularly preferably 4.0% by mass or less based on the total amount (100% by mass) of the water-soluble metalworking oil.

### <Component (B): Amine Compound>

Preferably, the water-soluble metalworking oil of one embodiment of the present invention further contains an amine compound (B). The water-soluble metalworking oil containing the component (B), when combined with dilution water to provide a metalworking fluid, is capable of becoming a metalworking fluid having a good emulsion state and more increased antibacterial properties, antirust properties, workability, and the like.

In the water-soluble metalworking oil of one embodiment of the present invention, one component (B) may be used singly, or two or more may be used in combination.

From the above viewpoint, the content of the component (B) in the water-soluble metalworking oil of one embodiment of the present invention is preferably 2 to 40% by mass, more preferably 4 to 35% by mass, even more preferably 6 to 30% by mass, yet more preferably 8 to 25% by mass, and particularly preferably 10 to 20% by mass based on the total amount (100% by mass) of the water-soluble metalworking oil.

Component (B) used in one embodiment of the present invention may be any of monoamine having one amino nitrogen atom within one molecule, diamine having two amino nitrogen atoms within one molecule, and polyamine having 3 or more amino nitrogen atoms within one molecule.

However, from the viewpoint of providing a water-soluble metalworking oil capable of becoming a metalworking fluid having more increased antibacterial properties, antirust properties, workability, and the like, component (B) used in one embodiment of the present invention preferably contains monoamine.

The content of monoamine is preferably 50 to 100% by mass, more preferably 60 to 100% by mass, more preferably 70 to 100% by mass, more preferably 80 to 100% by mass, even more preferably 80 to 100% by mass, even more preferably 85 to 100% by mass, yet more preferably 90 to 100% by mass, yet more preferably 95 to 100% by mass, and particularly preferably 98 to 100% by mass based on the total amount (100% by mass) of component (B) contained in the water-soluble metalworking oil.

Monoamine used as component (B) in one embodiment of the present invention is classified according to the number of substituents R into primary monoamine represented by the following formula (i), secondary monoamine represented by the following formula (ii), and tertiary monoamine represented by the following formula (iii).

From the viewpoint of providing a water-soluble metalworking oil capable of becoming a metalworking fluid having a good emulsion state and more increased antibacterial properties, antirust properties, workability, and the like when combined with dilution water to provide a metalworking fluid, the component (B) used in one embodiment of the present invention preferably contains at least tertiary monoamine, more preferably contains tertiary monoamine and at least one of primary monoamine and secondary monoamine, and even more preferably contains all of the primary monoamine, secondary monoamine, and tertiary monoamine.

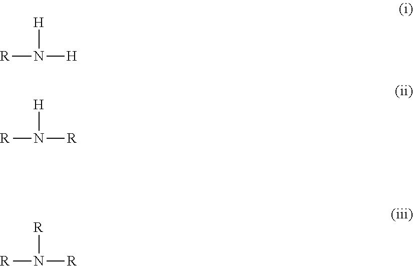

In the above formulae, R each independently represents a substituent. A plurality of R may be the same or may be different from each other. Examples of the substituent include an alkyl group, a hydroxyalkyl group, an alkenyl group, a cycloalkyl group, a phenyl group, and a benzyl group.

Examples of the alkyl group that can be selected as a substituent R include a methyl group, an ethyl group, a propyl group (a n-propyl group, an i-propyl group), a butyl group (a n-butyl group, an i-butyl group, a s-butyl group, a t-butyl group), a pentyl group (a n-pentyl group, an i-pentyl group, a neopentyl group), a hexyl group, a heptyl group, an octyl group, a 2-ethylhexyl group, a nonyl group, a decyl group, a undecyl group, a dodecyl group, a tridecyl group, a tetradecyl group, a pentadecyl group, a hexadecyl group, a heptadecyl group, and an octadecyl group.

The alkyl group may be a linear alkyl group or may be a branched alkyl group.

The number of carbon atoms of the alkyl group is preferably 1 to 30, more preferably 1 to 20, even more preferably 1 to 10, yet more preferably 1 to 6, and particularly preferably 1 to 4.

Examples of the hydroxyalkyl group that can be selected as a substituent R include groups obtained by replacing at least one hydrogen atom of the above alkyl groups with a hydroxyl group.

The alkyl group that constitutes the hydroxyalkyl group may also be a linear alkyl group or may be a branched alkyl group.

The number of carbon atoms of the hydroxyalkyl group is preferably 1 to 30, more preferably 1 to 20, even more preferably 1 to 10, yet more preferably 1 to 6, and particularly preferably 2 to 4.

Examples of the alkenyl group that can be selected as a substituent R include an ethenyl group (a vinyl group), a propenyl group, a butenyl group, a pentenyl group, a hexenyl group, a heptenyl group, an octenyl group, a nonenyl group, a decenyl group, a dodecenyl group, a tridecenyl group, a tetradecenyl group, a pentadecenyl group, a hexadecenyl group, and an octadecenyl group.

The alkenyl group may be a linear alkenyl group or may be a branched alkenyl group.

The number of carbon atoms of the alkenyl group is preferably 1 to 30, more preferably 1 to 20 carbon atoms, even more preferably 1 to 10 carbon atoms, yet more preferably 1 to 6 carbon atoms, and particularly preferably 1 to 3 carbon atoms.

Examples of the cycloalkyl group that can be selected as a substituent R include a cyclopropyl group, a cyclobutyl group, a cyclopentyl group, a cyclohexyl group, a cycloheptyl group, a cyclooctyl group, and an adamantyl group.

From the viewpoint of providing a water-soluble metalworking oil capable of becoming a metalworking fluid having a good emulsion state and more increased antibacterial properties, antirust properties, workability, and the like, when combined with dilution water, component (B) used in one embodiment of the present invention preferably contains alkanolamine having at least one hydroxyalkyl group.

Examples of alkanolamine include primary alkanolamine in which R in the above formula (i) is a hydroxyalkyl group, secondary alkanolamine in which at least one R in the above formula (ii) is a hydroxyalkyl group, and tertiary alkanolamine in which at least one R in the above formula (iii) is a hydroxyalkyl group.

Examples of primary alkanolamine include ethanolamine, propanolamine, butanolamine, and 2-amino-2-methyl-1-propanol.

Examples of secondary alkanolamine include monoethanolamine such as N-methylethanolamine, N-ethylethanolamine, N-propylethanolamine, N-butylethanolamine, N-octylethanolamine, N-stearylethanolamine, N-oleylethanolamine, N-cyclohexylethanolamine, N-phenylethanolamine, and N-benzylethanolamine; monopropanolamine such as N-methylpropanolamine, N-ethylpropanolamine, N-propylpropanolamine, N-butylpropanolamine, N-octylpropanolamine, N-stearylpropanolamine, N-oleylpropanolamine, N-cyclohexylpropanolamine, N-phenylpropanolamine, and N-benzylpropanolamine; diethanolamine, and dipropanolamine.

Examples of tertiary alkanolamine include monoethanolamine such as N-dimethylethanolamine, N-diethylethanolamine, N-dipropylethanolamine, N-dibutylethanolamine, N-dioctylethanolamine, N-distearylethanolamine, N-dioleylethanolamine, N-dicyclohexylethanolamine, N-diphenylethanolamine, and N-dibenzylethanolamine; monopropanolamine such as N-dimethylpropanolamine, N-diethylpropanolamine, N-dipropylpropanolamine, N-dibutylpropanolamine, N-dioctylpropanolamine, N-distearylpropanolamine, N-dioleylpropanolamine, N-dicyclohexylpropanolamine, N-diphenylpropanolamine, and N-dibenzylpropanolamine; diethanolamine such as N-methyldiethanolamine, N-ethyldiethanolamine, N-propyldiethanolamine, N-butyldiethanolamine, N-octyldiethanolamine, N-stearyldiethanolamine, N-oleyldiethanolamine, N-cyclohexyldiethanolamine, N-phenyldiethanolamine, and N-benzyldiethanolamine; dipropanolamine such as N-methyldipropanolamine, N-ethyldipropanolamine, N-propyldipropanolamine, N-butyldipropanolamine, N-octyldipropanolamine, N-stearyldipropanolamine, N-oleyldipropanolamine, N-cyclohexyldipropanolamine, N-phenyldipropanolamine, and N-benzyldipropanolamine; triethanolamine, and tripropanolamine (such as triisopropanolamine).

Among these, from the viewpoint of providing a water-soluble metalworking oil capable of becoming a metalworking fluid having a good emulsion state and more increased antibacterial properties, antirust properties, workability, and the like, when combined with dilution water, component (B) used in one embodiment of the present invention preferably contains at least tertiary alkanolamine, more preferably contains tertiary alkanolamine and at least one of primary alkanolamine and secondary alkanolamine, and even more preferably contains all of the primary alkanolamine, secondary alkanolamine, and tertiary alkanolamine.

The content of alkanolamine may be preferably 5% by mass or more, more preferably 10% by mass or more, more preferably 20% by mass or more, even more preferably 25% by mass or more, yet more preferably 30% by mass or more, particularly preferably 35% by mass or more, moreover, 40% by mass or more, 42% by mass or more, 44% by mass or more, 46% by mass or more, 48% by mass or more, 50% by mass or more, 55% by mass or more, or 60% by mass or more, and may be 100% by mass or less, 95% by mass or less, 90% by mass or less, 85% by mass or less, 80% by mass or less, 75% by mass or less, 70% by mass or less, 68% by mass or less, 66% by mass or less, 64% by mass or less, 62% by mass or less, 60% by mass or less, 58% by mass or less, or 55% by mass or less based on the total amount (100% by mass) of component (B) contained in the water-soluble metalworking oil.

Component (B) used in one embodiment of the present invention preferably contains alicyclic amine.

Examples of alicyclic amine include primary alicyclic amine wherein R in the above formula (i) is a cycloalkyl group, secondary alicyclic amine wherein at least one R in the above formula (ii) is a cycloalkyl group; and tertiary alicyclic amine wherein at least one R in the above formula (iii) is a cycloalkyl group.

Examples of primary alicyclic amine include N-cyclohexylamine.

Examples of secondary alicyclic amine include monocyclohexylamine such as N-methylcyclohexylamine, N-ethylcyclohexylamine, N-propylcyclohexylamine, and N-oleylcyclohexylamine; monocyclohexylalkanolamine such as N-cyclohexylethanolamine and N-cyclohexylpropanolamine; and N-dicyclohexylamine.

Examples of tertiary alicyclic amine include dialkylmonocyclohexylamine such as N-dimethylcyclohexylamine, N-diethylcyclohexylamine, N-dipropylcyclohexylamine, N-dioleylcyclohexylamine, and N-dicyclohexylamine; monocyclohexyldialkanolamine such as N-cyclohexyldiethanolamine and N-cyclohexyldipropanolamine; monoalkyldicyclohexylamine such as N-methyldicyclohexylamine, N-ethyldicyclohexylamine, N-propyldicyclohexylamine, and N-oleyldicyclohexylamine; dicyclohexylalkanolamine such as N-dicyclohexylethanolamine and N-dicyclohexylpropanolamine; and tricyclohexylamine.

Among these, from the viewpoint of providing a water-soluble metalworking oil capable of becoming a metalworking fluid having a good emulsion state and more increased antibacterial properties, antirust properties, workability, and the like when combined with dilution water to provide a metalworking fluid, the component (B) used in one embodiment of the present invention preferably contains tertiary alicyclic amine, and more preferably contains tertiary alicyclic amine of formula (iii) wherein two R groups are cycloalkyl groups.

The content of alicyclic amine may be preferably 10% by mass or more, more preferably 15% by mass or more, even more preferably 20% by mass or more, yet more preferably 25% by mass or more, particularly preferably 30% by mass or more, and may be 100% by mass or less, 95% by mass or less, 90% by mass or less, 85% by mass or less, 80% by mass or less, 75% by mass or less, 70% by mass or less, or 65% by mass or less based on the total amount (100% by mass) of component (B) contained in the water-soluble metalworking oil.

The water-soluble metalworking oil of one embodiment of the present invention may contain another amine (including diamine and polyamine) other than alkanolamine and alicyclic amine as component (B).

The content of another amine may be 0 to 50% by mass, 0 to 40% by mass, 0 to 30% by mass, 0 to 20% by mass, 0 to 10% by mass, 0 to 5.0% by mass, 0 to 2.0% by mass, 0 to 1.0% by mass, 0 to 0.10% by mass, 0 to 0.01% by mass, 0 to 0.001% by mass, 0 to 0.0001% by mass, or 0 to 0.00001% by mass based on the total amount (100% by mass) of component (B) contained in the water-soluble metalworking oil.

### <Component (C): Fatty Acid>

Preferably, the water-soluble metalworking oil of one embodiment of the present invention further contains a fatty acid (C).

Containing component (C), the water-soluble metalworking oil is capable of becoming a metalworking fluid having more increased emulsion stability, antirust properties, workability, and the like.

In the water-soluble metalworking oil of one embodiment of the present invention, one component (C) may be used singly, or two or more may be used in combination.

From the above viewpoint, in the water-soluble metalworking oil of one embodiment of the present invention, the content of the component (C) is preferably 3 to 60% by mass, more preferably 5 to 50% by mass, even more preferably 9 to 40% by mass, yet more preferably 12 to 35% by mass, particularly preferably 14 to 30% by mass, and, moreover, may be 15% by mass or more, 16% by mass or more, or 17% by mass or more, and may be 27% by mass or less, 25% by mass or less, 23% by mass or less, or 21% by mass or less based on the total amount (100% by mass) of the water-soluble metalworking oil.

Examples of component (C) used in one embodiment of the present invention include fatty acid, hydroxy fatty acid, aliphatic dicarboxylic acid, dimer acid of fatty acid, and polymerized fatty acid of hydroxy unsaturated fatty acid.

Examples of the fatty acid include saturated aliphatic monocarboxylic acid such as octanoic acid, 2-ethylhexanoic acid, decanoic acid, neodecanoic acid, undecanoic acid, dodecanoic acid, tridecanoic acid, pentadecanoic acid, heptadecanoic acid, nonadecanic acid, myristic acid, palmitic acid, stearic acid, arachidic acid, behenic acid, and isostearic acid, and unsaturated aliphatic monocarboxylic acid such as octenoic acid, nonenoic acid, decenoic acid, undecenoic acid, oleic acid, elaidic acid, erucic acid, nervonic acid, linoleic acid, γ-linolenic acid, arachidonic acid, α-linolenic acid, stearidonic acid, eicosapentaenoic acid, and docosahexaenoic acid.

A mixture of unsaturated fatty acid may be used, such as tall oil fatty acid, soybean oil fatty acid, palm oil fatty acid, linseed oil fatty acid, rice bran oil fatty acid, and cottonseed oil fatty acid.

The number of carbon atoms in the fatty acid is preferably 8 to 30, more preferably 10 to 25, and even more preferably 10 to 20.

Examples of the hydroxy fatty acid include hydroxylauric acid, hydroxymyristic acid, hydroxypalmitic acid, hydroxystearic acid, hydroxyarachic acid, hydroxybehenic acid, and hydroxyoctadecenoic acid.

The number of carbon atoms of the hydroxy fatty acid is preferably 8 to 30, more preferably 10 to 25, and even more preferably 10 to 20 carbon atoms.

Examples of the aliphatic dicarboxylic acid include sebacic acid, dodecanedioic acid, dodecylsuccinic acid, laurylsuccinic acid, stearylsuccinic acid, and isostearylsuccinic acid.

The number of carbon atoms of the aliphatic dicarboxylic acid is preferably 8 to 30, more preferably 10 to 25, and even more preferably 10 to 20 carbon atoms.

Examples of the hydroxy unsaturated fatty acid constituting a polymerized fatty acid of the hydroxy unsaturated fatty acid include ricinoleic acid (12-hydroxyoctadec-9-enoic acid). A fatty acid mixture containing recinoleic acid, such as castor oil, may be used.

Examples of the polymerized fatty acid of the hydroxy unsaturated fatty acid include condensed fatty acid that is a dehydrative polycondensation product of hydroxy unsaturated fatty acid, and condensed fatty acid obtained by dehydratively condensing an alcoholic hydroxyl group of condensed fatty acid that is a dehydrative polycondensation product of hydroxy unsaturated fatty acid and monocarboxylic acid.

From the viewpoint of providing a water-soluble metalworking oil capable of becoming a metalworking fluid having more increased workability, the acid value of component (C) is usually 0 mgKOH/g or more, preferably 10 to 100 mgKOH/g, more preferably 20 to 90 mgKOH/g, and even more preferably 30 to 80 mgKOH/g.

The hydroxyl value of component (C) is preferably 0 to 80 mgKOH/g, more preferably 0 to 60 mgKOH/g, and even more preferably 0 to 40 mgKOH/g.

From the above viewpoint, the ratio of the acid value to the hydroxyl value of component (C) [acid value/hydroxyl value] is preferably 1.5 to 15, more preferably from 2.0 to 10, and even more preferably from 2.5 to 9.5.

The saponification value of component (C) is preferably 180 to 220 mgKOH/g, more preferably 190 to 210 mgKOH/g, and even more preferably 195 to 205 mgKOH/g.

Herein, the acid value means a value measured in accordance with JIS K 2501:2003 (indicator photometric titration method), the hydroxyl value means a value measured in accordance with JIS K 0070:1992, and the saponification value means a value measured in accordance with JIS K 2503:1996.

### <Nonionic Surfactant (D)>

Preferably, the water-soluble metalworking oil of one embodiment of the present invention further contains a nonionic surfactant (D). Containing the nonionic surfactant (D), the water-soluble metalworking oil is capable of becoming a metalworking fluid having more increased emulsion stability and workability.

In the water-soluble metalworking oil of one embodiment of the present invention, one component (D) may be used singly, or two or more may be used in combination.

From the above viewpoint, in the water-soluble metalworking oil of one embodiment of the present invention, the content of the component (D) is preferably 0.1 to 15.0% by mass, more preferably 0.2 to 10.0% by mass, even more preferably 0.3 to 8.0% by mass, yet more preferably 0.5 to 6.0% by mass, particularly preferably 0.7 to 4.0% by mass, and, moreover, may be 0.9% by mass or more, 1.0% by mass or more, 1.2% by mass or more, or 1.5% by mass or more, and may be 3.8% by mass or less, 3.5% by mass or less, 3.2% by mass or less, 3.0% by mass or less, 2.8% by mass or less, or 2.5% by mass or less based on the total amount (100% by mass) of the water-soluble metalworking oil.

From the viewpoint of providing a water-soluble metalworking oil capable of becoming a metalworking fluid having more increased emulsion stability and workability, the HLB of component (D) used in one embodiment of the present invention is preferably 6.0 or more, more preferably 7.0 or more, even more preferably 8.0 or more, yet more preferably 9.0 or more, and particularly preferably 10.0 or more, and is 18.0 or less, preferably 17.0 or less, more preferably 16.0 or less, even more preferably 15.0 or less, and yet more preferably 14.5 or less.

Herein, HLB means a value calculated by Griffin's method.

Examples of the component (D) used in one embodiment of the present invention include alkylene glycol, polyoxyalkylene glycol, polyoxyalkylene alkyl ether, polyoxyalkylene aryl ether, an alkylphenol ethylene oxide adduct, a higher alcohol ethylene oxide adduct, a polyoxyalkylene fatty acid ester, a fatty acid ester of glycerin and pentaerythritol, a fatty acid ester of sucrose, a fatty acid ester of a polyoxyalkylene adduct of polyhydric alcohol, alkyl polyglycoside, and fatty acid alkanolamide.

Among these, from the viewpoint of providing a water-soluble metalworking oil capable of becoming a metalworking fluid having more increased emulsion stability and workability, component (D) used in one embodiment of the present invention preferably contains polyoxyalkylene alkyl ether.

The content of polyoxyalkylene alkyl ether is preferably 50 to 100% by mass, more preferably 70 to 100% by mass, even more preferably 80 to 100% by mass, yet more preferably 90 to 100% by mass, and particularly preferably 95 to 100% by mass based on the total amount (100% by mass) of component (D) contained in the water-soluble metalworking oil.

### <Component (E): Base Oil>

Preferably, the water-soluble metalworking oil of one embodiment of the present invention further contains a base oil (E).

Containing the component (E), the water-soluble metalworking oil is capable of becoming a metalworking fluid having more increased workability.

In the water-soluble metalworking oil of one embodiment of the present invention, one component (E) may be used singly, or two or more may be used in combination.

From the above viewpoint, in the water-soluble metalworking oil of one embodiment of the present invention, the content of the component (E) is preferably 9% by mass or more, more preferably 12% by mass or more, and even more preferably 14% by mass or more, and is preferably 80% by mass or less, more preferably 70% by mass or less, and even more preferably 60% by mass or less based on the total amount (100% by mass) of the water-soluble metalworking oil.

When providing an emulsion-type oil classified as A1 as stipulated in JIS K 2241:2017, the content of the component (E) may be 20% by mass or more, 25% by mass or more, 30% by mass or more, 35% by mass or more, or 40% by mass or more based on the total amount (100% by mass) of the oil.

When providing a soluble-type oil classified as A2 as stipulated in JIS K 2241:2017, the content of the component (E) may be 50% by mass or less, 45% by mass or less, 40% by mass or less, 35% by mass or less, or 30% by mass or less based on the total amount (100% by mass) of the oil.

In the water-soluble metalworking oil of one embodiment of the present invention, the content of the component (E) based on total 100% by mass of the component (B) and the component (E) is preferably less than 90% by mass, more preferably less than 85% by mass, even more preferably less than 80% by mass, and, moreover, may be less than 79% by mass, less than 78% by mass, less than 77% by mass, less than 76% by mass, less than 75% by mass, less than 70% by mass, less than 65% by mass, less than 60% by mass, or less than 55% by mass.

The component (E) used in one embodiment of the present invention may be at least one selected from mineral oils and synthetic oils.

Examples of mineral oils include atmospheric residue obtained by performing atmospheric distillation on crude oil such as paraffinic crude oil, intermediate crude oil, and naphthenic crude oil; distillate obtained by performing vacuum distillation on such atmospheric residue; and refined oil obtained by performing on such distillate one or more refining treatments such as solvent deasphalting, solvent extraction, hydrocracking, solvent dewaxing, catalytic dewaxing, and hydrorefining.

Examples of synthetic oils include polyα-olefins such as α-olefin homopolymers or α-olefin copolymers (e.g., α-olefin copolymers having 8 to 14 carbon atoms, such as ethylene-α-olefin copolymers); isoparaffin; polyalkylene glycol; ester oils such as polyol esters, dibasic acid esters, and phosphoric acid esters; ether oils such as polyphenyl ether; alkylbenzene; alkyl naphthalene; synthetic oils (GTL) obtained by isomerizing wax (GTL wax (Gas-To-Liquids WAX)) produced from natural gas by Fischer-Tropsch process or the like.

### <Component (F): Water>

The water-soluble metalworking oil of one embodiment of the present invention may further contain water (F).

Containing water, the water-soluble metalworking oil can become flame retardant and have good storage stability.

Water, which is the component (F) used in one embodiment of the present invention, is not particularly limited, and may be, for example, any of distilled water, ion exchanged water, tap water, water for industrial use, and the like.

In the water-soluble metalworking oil of one embodiment of the present invention, the content of the component (F) is 100 parts by mass or less, preferably 1 to 90 parts by mass, more preferably 3 to 80 parts by mass, and even more preferably 5 to 70 parts by mass based on 100 parts by mass of the total amount of components excluding water in the water-soluble metalworking oil.

When providing an emulsion-type oil classified as A1 as stipulated in JIS K 2241:2017, the content of the component (F) may be 60 parts by mass or less, 50 parts by mass or less, 40 parts by mass or less, 30 parts by mass or less, 20 parts by mass or less, or 15 parts by mass or less based on 100 parts by mass of the total amount of components excluding water in the water-soluble metalworking oil.

When providing a soluble-type oil classified as A2 as stipulated in JIS K 2241:2017, the content of the component (F) may be 10 parts by mass or more, 15 parts by mass or more, 20 parts by mass or more, 25 parts by mass or more, or 30 parts by mass or more based on 100 parts by mass of the total amount of components excluding water in the water-soluble metalworking oil.

In the water-soluble metalworking oil of one embodiment of the present invention, the content of the component (F) is preferably 1 to 50% by mass, more preferably 2 to 45% by mass, and even more preferably 3 to 40% by mass based on the total amount (100% by mass) of the water-soluble metalworking oil.

When providing an emulsion-type oil classified as A1 as stipulated in JIS K 2241:2017, the content of the component (F) may be 35% by mass or less, 30% by mass or less, 25% by mass or less, 20% by mass or less, 15% by mass or less, or 10% by mass or less based on the total amount (100% by mass) of the water-soluble metalworking oil.

When providing a soluble-type oil classified as A2 as stipulated in JIS K 2241:2017, the content of the component (F) may be 10% by mass or more, 15% by mass or more, 20% by mass or more, 25% by mass or more, or 30% by mass or more based on the total amount (100% by mass) of the water-soluble metalworking oil.

### <Petroleum Sulfonate>

While the water-soluble metalworking oil of one embodiment of the present invention may contain petroleum sulfonate such as calcium sulfonate and sodium sulfonate, a lower petroleum sulfonate content is preferable from the viewpoint of providing a water-soluble metalworking oil capable of becoming a metalworking fluid having excellent workability, more preferably the water-soluble metalworking oil is substantially free of petroleum sulfonate, and even more preferably the water-soluble metalworking oil is free of petroleum sulfonate.

When the water-soluble metalworking oil of one embodiment of the present invention is substantially free of petroleum sulfonate, the specific petroleum sulfonate content is preferably less than 10 parts by mass, more preferably less than 5 parts by mass, even more preferably less than 1 part by mass, yet more preferably less than 0.1 parts by mass, and particularly preferably less than 0.01 parts by mass based on 100 parts by mass of the total amount of the component (A) contained in the water-soluble metalworking oil.

When the water-soluble metalworking oil of one embodiment of the present invention is substantially free of petroleum sulfonate, the petroleum sulfonate content is preferably less than 1.0% by mass, more preferably less than 0.1% by mass, even more preferably less than 0.01% by mass, yet more preferably less than 0.001% by mass, and particularly preferably less than 0.0001% by mass based on the total amount (100% by mass) of the water-soluble metalworking oil.

Being “free of petroleum sulfonate” means that metal atoms (such as Ca and Na) derived from petroleum sulfonate are not detected when the oil of interest is measured in accordance with JPI-5S-38-2003.

### <Other Various Additives>

The water-soluble metalworking oil of one embodiment of the present invention may further contain, as necessary, other various additives other than the above components (A) to (F) as long as the effects of the present invention are not impaired.

Examples of such other various additives include anionic surfactants, cationic surfactants, extreme pressure additives, metal deactivators, emulsification aids, antibacterial agents, antifoaming agents, antioxidants, and oily agents.

One of these various additives may be used singly, or two or more may be used in combination.

In the water-soluble metalworking oil of one embodiment of the present invention, the content of each of these various additives is suitably set according to the type and the function of each component, and is preferably 0.01 to 20% by mass, more preferably 0.03 to 15% by mass, and even more preferably 0.01 to 10% by mass based on the total amount (100% by mass) of the water-soluble metalworking oil.

Examples of the anionic surfactant include polyoxyethylene alkyl ether carboxylic acids, polyoxyethylene alkyl ether phosphoric acids, alkylbenzene sulfonic acids, α-olefinsulfonic acids, and salts thereof.

The acid value of anionic surfactants is preferably 20 to 250 mgKOH/g, more preferably 30 to 200 mgKOH/g, even more preferably 40 to 190 mgKOH/g, and yet more preferably 50 to 180 mgKOH/g.

Examples of cationic surfactants include alkyltrimethylammonium salts, dialkyldimethylammonium salts, and alkyldimethylbenzylammonium salts.

Examples of extreme pressure additives include chloric extreme pressure additives such as chlorinated paraffin, chlorinated fatty acid, and chlorinated fatty oil; sulfuric extreme pressure additives such as sulfurized olefin, sulfurized lard, alkyl polysulfide, and sulfurized fatty acid; and phosphoric extreme pressure additives such as phosphoric esters, phosphorous esters, thiophosphoric esters, salts thereof, phosphines, and tricresyl phosphate.

Examples of metal deactivators include benzotriazoles, imidazolines, pyrimidine derivatives, and thiadiazoles.

Examples of emulsifying aids include unsaturated fatty acid esters such as methyl oleate, ethyl oleate, and propyl oleate.

Examples of antibacterial agents include isothiazoline compounds, triazine compounds, alkylbenzimidazole compounds, and metal pyrithione salts.

Examples of antifoaming agents include silicone antifoaming agents, fluorosilicone antifoaming agents, and polyacrylates.

Examples of antioxidants include amine antioxidants such as alkylated diphenylamine, phenylnaphthylamine, and alkylated phenylnaphthylamine; and phenolic antioxidants such as 2,6-di-t-butylphenol, 4,4′-methylenebis(2,6-di-t-butylphenol), isooctyl-3-(3,5-di-t-butyl-4-hydroxyphenyl)propionate, and n-octadecyl-3-(3,5-di-t-butyl-4-hydroxyphenyl)propionate.

Examples of oily agents include alcohols such as lauryl alcohol, myristyl alcohol, palmityl alcohol, stearyl alcohol, and oleyl alcohol.

### <Method for Producing Water-Soluble Metalworking Oil>

The method for producing a water-soluble metalworking oil of one embodiment of the present invention is not particularly limited, and is preferably a method comprising the step of blending the above component (A) and, optionally, the components (B) to (F) and other various additives. The order of blending the respective components can be suitably set.

### [Properties of Water-Soluble Metalworking Oil]

The acid value of the water-soluble metalworking oil of one embodiment of the present invention is preferably 10 to 70 mgKOH/g, more preferably 15 to 60 mgKOH/g, and even more preferably 20 to 50 mgKOH/g.

The base value of the water-soluble metalworking oil of one embodiment of the present invention is preferably 10 to 100 mgKOH/g, more preferably 20 to 90 mgKOH/g, and even more preferably 30 to 80 mgKOH/g.

Herein, the base value means a value measured in accordance with JIS K 2501:2003 (HCl method).

The ratio of the base value to the acid value [base value/acid value] of the water-soluble metalworking oil of one embodiment of the present invention is preferably 1.0 to 3.0, more preferably 1.1 to 2.5, even more preferably 1.3 to 2.2, and yet more preferably 1.5 to 2.0.

When the ratio is 1.0 or more, a water-soluble metalworking oil having good decay resistance can be provided. On the other hand, when the ratio is 3.0 or less, irritation to the human skin can be small, and thus the water-soluble metalworking oil is preferable in terms of handleability.

### [Form of Metalworking Fluid]

The metalworking fluid of the present invention is obtained by using the above metalworking oil of one embodiment of the present invention as a stock solution, and adding dilution water to the metalworking oil.

Dilution water may be any of, for example, distilled water, ion exchanged water, tap water, or water for industrial use.

The amount of dilution water added when preparing the metalworking fluid is more than 100 parts by mass based on 100 parts by mass of the total amount of components other than water of the water-soluble metalworking oil and, preferably, is suitably regulated so as to attain a desired dilute concentration.

The dilute concentration of the metalworking fluid of one embodiment of the present invention is preferably 1 to 50% by volume, more preferably 3 to 40% by volume, and even more preferably 5 to 20% by volume.

Herein, the “dilute concentration of the metalworking fluid” means a value calculated from the following equation:

“Dilute concentration of metalworking fluid (% by mass)”=[Mass of metalworking oil before dilution]/[[Mass of metalworking oil before dilution]+[Mass of dilution water]]×100.

### [Applications of Metalworking Fluid, and Metalworking Method]

The metalworking fluid of one suitable embodiment of the present invention has better swarf dispersibility and workability than conventional metalworking fluids, and can be suitably used in metalworking.

The workpiece to be processed using the metalworking fluid of one embodiment of the present invention is not particularly limited, and the metalworking fluid is particularly suitable for workpieces composed of metals selected from the group consisting of titanium, titanium alloy, alloy steel, nickel-based alloy, niobium alloy, tantalum alloy, molybdenum alloy, tungsten alloy, stainless steel, and high-manganese steel.

Accordingly, the present invention can also provide [1] and [2] below:
[1] A method of use comprising applying the above metalworking fluid of one embodiment of the present invention to processing of a metal workpiece.
[2] A metalworking method comprising applying the above metalworking fluid of one embodiment of the present invention to process a metal workpiece.

The details of the workpiece set forth in [1] and [2] are as described above.

In [1] and [2], examples of processing of the workpiece include cutting, grinding, punching, polishing, spinning, drawing, and rolling.

In the method of use according to [1] and the metalworking method according to [2], the metalworking fluid is used such that the above water-soluble metalworking oil of one embodiment of the present invention is blended with dilution water and then fed to, and thus brought into contact with, the workpiece. The metalworking fluid provides lubrication between the workpiece and the work tool. Moreover, the metalworking fluid is also used to remove swarf, prevent rust of the workpiece, cool the tool and the work piece, and the like.

### EXAMPLES

Next, the present invention will now be described in more detail by way of Examples, but the present invention is not limited to these Examples in any way.

In the following Examples, the methods for measuring and calculating the following physical property values are as follows:
(1) Kinematic viscosity, viscosity index Measured and calculated in accordance with JIS K 2283:2000.
(2) Acid value (indicator photometric titration method) Measured in accordance with JIS K 2501:2003 (indicator photometric titration method).
(3) Base value (HCl method) Measured in accordance with JIS K 2501:2003 (HCl method).
(4) Hydroxyl value Measured in accordance with JIS K 0070:1992.
(5) Saponification value Measured in accordance with JIS K 2503:1996.
(6) HLB
   Calculated based on Griffin's method.

### Examples 1 to 13, Comparative Examples 1 to 2

Various components of the types shown in Tables 1 and 2 were added and mixed in the amounts shown in Tables 1 and 2 to prepare respective water-soluble metalworking oils. Details of each component used in the preparation of the water-soluble metalworking oils are as follows.

### <Component (A)>

2-phenoxyethanol

### <Component (B)>

Amine (b-1): N-Methylethanolamine, secondary monoamine
Amine (b-2): 2-amino-2-methyl-1-propanol, primary monoamine
Amine (b-3): N-Methyldiethanolamine, tertiary monoamine
Amine (b-4): Triisopropanolamine, tertiary monoamine
Amine (b-5): N-Methyldicyclohexylamine, tertiary monoamine

### <Component (C)>

Fatty acid (c-1): Fatty acid mixture of dodecanedioic acid, neodecanoic acid, tall oil fatty acid, and ricinoleic acid polymerized fatty acid (castor oil polymerized fatty acid), acid value=21.9 mg KOH/g, hydroxyl value=1.0 mgKOH/g
Fatty acid (c-2): Fatty acid mixture of dodecanedioic acid, neodecanoic acid, tall oil fatty acid, and ricinoleic acid polymerized fatty acid (castor oil polymerized fatty acid), acid value=27.5 mg KOH/g, hydroxyl value=1.1 mgKOH/g

### <Component (D)>

Nonionic surfactant: Polyoxyalkylene alkyl ether, HLB=12.7

### <Component (E)>

Paraffinic mineral oil: Paraffinic mineral oil having kinematic viscosity at 40° C.=7.117 mm²/s, viscosity index=109.

### <Component (F)>

Water

### <Other Components>

Anionic surfactant (1): Polyoxyethylene oleyl ether carboxylic acid, acid value=69.3 mgKOH/g.
Anionic surfactant (2): polyoxyethylene alkyl ether phosphoric acids, acid value=176 mgKOH/g.
Metal deactivator: Benzotriazole
Emulsifying aid: methyl oleate
Antibacterial agent: 1,2-Benzoisothiazolin-3-on
Antifoaming agent: Silicone defoaming agent

### <Petroleum Sulfonate>

Na sulfonate: Neutral sodium sulfonate, base value=3.85 mg KOH/g
Ca sulfonate: Neutral calcium sulfonate, base value=17.9 mg KOH/g

The acid value, the base value, and the ratio of base value/acid value of the prepared water-soluble metalworking oils were measured and calculated and, also, the following evaluations were made using the water-soluble metalworking oils. The results thereof are shown in Tables 1 and 2.

### (1) Classification of Oil Type

In accordance with the provisions of JIS K 2241:2017, the water-soluble metalworking oils were classified as emulsion-type oils A1 or soluble-type oils A2 of this standard. In Tables 1 and 2, “E” is given when classified as an emulsion-type oil A1, and “S” is given when classified as a soluble-type oil A2.

### (2) Evaluation of Stock Solution Stability

A 100 ml transparent glass bottle was charged with 80 ml of a prepared water-soluble metalworking oil and left to stand in a thermostatic oven at 30° C. for 24 hours, then the appearance was visually inspected, and the stock solution stability was evaluated according to the following criteria:
“A”: No oil gelation was observed.
“F”: Oil gelation was observed.

### (3) Evaluation of Graphite Dispersibility

5 mL of the water-soluble metalworking oil was added to a graduated cylinder and then 95 mL of ion exchanged water was added thereto to prepare a metalworking fluid having a dilute concentration of 5% by volume. After 3 g of graphite powder was added to the metalworking fluid, the mixture was shaken for about 30 seconds, then the time until graphite aggregated in the metalworking fluid was measured, and the graphite dispersibility was evaluated according to the following criteria:
“A”: Graphite remained dispersed for 3 minutes or longer in the metalworking fluid without aggregation.
“F”: Graphite was confirmed aggregated in the metalworking fluid before a lapse of 3 minutes.

### (4) Evaluation of Workability

The water-soluble metalworking oil was diluted with ion exchanged water to prepare a metalworking fluid having a dilute concentration of 5% by volume. Using the prepared metalworking fluid, a pilot hole was drilled and reamed under the following conditions, and then a tapping torque test was performed to measure the maximum tapping torque during processing. Measurement was performed three times, and the average value and the maximum value of the results are shown in Tables 1 and 2.

It can be said that the smaller the average value and the maximum value are, the better the metal workability of the metalworking fluid used is.

### <Pilot Hole Drilling Conditions>

Machine used: Tapping Center MTV-T350 (manufactured by Mectron Inc.)
Drill: Carbide Drill for Nonferrous Metal Machining, Medium Type, NF-GDN (manufactured by OSG Corporation), Drill diameter: 7.2 mm
   Cutting speed: 130 m/min
   Rotational speed: 5747 min-1
   Feeding speed: 1320 ram/min
   Feed per revolution: 0.23 mm/rev
   Depth: 18 mm
   Reamer: Carbide Straight Reamer CRM (manufactured by OSG Corporation), Reamer diameter: 7.34 mm
   Cutting speed: 20 m/min
   Rotational speed: 867 min-1
   Feeding speed: 87 ram/min
   Feed per revolution: 0.10 mm/rev
   Depth: 15 mm

### <Tapping Torque Test>

Tester used: Megatap II (micro-electronische Gerate GmbH)
Tap: Nu-Roll Tap B-NRT RH7 B M8×1.25 (manufactured by OSG Corporation)
   Cutting speed: 10 m/min
   Feed: 1.0 mm/rev
   Depth: 12.5 mm
   Number of processed samples n: 3
   Material to be cut: A6061 (JIS standard)

TABLE 1

| | | | | | | | | | | | | Compar- |
|---|---|---|---|---|---|---|---|---|---|---|---|---|
| | | | | | | | | | | | | ative |
| | | | | Exam- | Exam- | Exam- | Exam- | Exam- | Exam- | Exam- | Exam- | Exam- |
| | | | | ple | ple | ple | ple | ple | ple | ple | ple | ple |
| | | | | 1 | 2 | 3 | 4 | 5 | 6 | 7 | 8 | 1 |
| Composition | Component | 2-Phenoxy- | % by | 3.50 | 3.50 | 3.50 | 3.50 | 3.50 | 1.00 | 2.00 | 3.00 | 0.50 |
| of water- | (A) | ethanol | mass | | | | | | | | | |
| soluble | Component | Amine (b-1) | % by | 0.80 | | 1.30 | 0.80 | 0.80 | 0.80 | 0.80 | 0.80 | 0.80 |
| metal- | (B) | | mass | | | | | | | | | |
| working | | Amine (b-2) | % by | 0.70 | 1.30 | | 0.70 | 0.70 | 0.70 | 0.70 | 0.70 | 0.70 |
| oil | | | mass | | | | | | | | | |
| | | Amine (b-3) | % by | 2.00 | 2.60 | 2.00 | 2.00 | 2.00 | 2.00 | 2.00 | 2.00 | 2.00 |
| | | | mass | | | | | | | | | |
| | | Amine (b-4) | % by | 2.50 | 2.50 | 2.60 | 2.50 | 2.50 | 2.50 | 2.50 | 2.50 | 2.50 |
| | | | mass | | | | | | | | | |
| | | Amine (b-5) | % by | 7.00 | 7.00 | 7.00 | 7.00 | 7.00 | 7.00 | 7.00 | 7.00 | 7.00 |
| | | | mass | | | | | | | | | |
| | Component | Fatty acid (c-1) | % by | 17.50 | 17.50 | 17.50 | 17.50 | 17.50 | 17.50 | 17.50 | 17.50 | 17.50 |
| | (C) | | mass | | | | | | | | | |
| | Component | Nonionic | % by | 2.00 | 2.00 | 2.00 | 2.00 | 2.00 | 2.00 | 2.00 | 2.00 | 2.00 |
| | (D) | surfactant | mass | | | | | | | | | |
| | Component | Paraffinic | % by | 45.45 | 45.05 | 45.55 | 42.45 | 42.45 | 47.95 | 46.95 | 45.95 | 48.45 |
| | (E) | mineral oil | mass | | | | | | | | | |
| | Component | Water | % by | 8.00 | 8.00 | 8.00 | 8.00 | 8.00 | 8.00 | 8.00 | 8.00 | 8.00 |
| | (F) | | mass | | | | | | | | | |
| | Other | Anionic | % by | 0.80 | 0.80 | 0.80 | 0.80 | 0.80 | 0.80 | 0.80 | 0.80 | 0.80 |
| | components | surfactant (1) | mass | | | | | | | | | |
| | | Anionic | % by | 0.50 | 0.50 | 0.50 | 0.50 | 0.50 | 0.50 | 0.50 | 0.50 | 0.50 |
| | | surfactant (2) | mass | | | | | | | | | |
| | | Metal deactivator | % by | 1.00 | 1.00 | 1.00 | 1.00 | 1.00 | 1.00 | 1.00 | 1.00 | 1.00 |
| | | | mass | | | | | | | | | |
| | | Emulsifying aid | % by | 8.00 | 8.00 | 8.00 | 8.00 | 8.00 | 8.00 | 8.00 | 8.00 | 8.00 |
| | | | mass | | | | | | | | | |
| | | Antibacterial | % by | 0.20 | 0.20 | 0.20 | 0.20 | 0.20 | 0.20 | 0.20 | 0.20 | 0.20 |
| | | agent | mass | | | | | | | | | |
| | | Antibacterial | % by | 0.05 | 0.05 | 0.05 | 0.05 | 0.05 | 0.05 | 0.05 | 0.05 | 0.05 |
| | | agent | mass | | | | | | | | | |
| | Petroleum | Na sulfonate | % by | | | | 3.00 | | | | | |
| | sulfonate | | mass | | | | | | | | | |
| | | Ca sulfonate | % by | | | | | 3.00 | | | | |
| | | | mass | | | | | | | | | |
| | Total | | % by | 100.00 | 100.00 | 100.00 | 100.00 | 100.00 | 100.00 | 100.00 | 100.00 | 100.00 |
| | | | mass | | | | | | | | | |
| | Component (A)/Component (B) | | — | 0.27 | 0.26 | 0.27 | 0.27 | 0.27 | 0.08 | 0.15 | 0.23 | 0.04 |
| | Component (A)/Component (C) | | — | 0.20 | 0.20 | 0.20 | 0.20 | 0.20 | 0.06 | 0.11 | 0.17 | 0.03 |
| | Component (A)/Component (D) | | — | 1.75 | 1.75 | 1.75 | 1.75 | 1.75 | 0.50 | 1.00 | 1.50 | 0.25 |
| | Component (B)/Component (C) | | — | 0.74 | 0.77 | 0.74 | 0.74 | 0.74 | 0.74 | 0.74 | 0.74 | 0.74 |
| Properties | Acid value of water-soluble | | mgKOH/ | 27.0 | 27.5 | 27.3 | 27.6 | 27.8 | 27.4 | 27.2 | 27.3 | 27.0 |
| | metalworking oil | | g | | | | | | | | | |
| | Base value of water-soluble | | mgKOH/ | 45.1 | 44.7 | 45.0 | 45.7 | 46.4 | 45.4 | 45.5 | 45.2 | 45.1 |
| | metalworking oil | | g | | | | | | | | | |
| | Base value/acid value | | mgKOH/ | 1.7 | 1.6 | 1.6 | 1.7 | 1.7 | 1.7 | 1.7 | 1.7 | 1.7 |
| | | | g | | | | | | | | | |
| Evaluation | (1) Classification of oil type | | — | E | E | E | E | E | E | E | E | E |
| item | (2) Evaluation of stock | | — | A | A | A | A | A | A | A | A | F |
| | solution stability | | | | | | | | | | | |
| | (3) Evaluation of graphite | | — | A | A | A | A | A | A | A | A | F |
| | dispersibility | | | | | | | | | | | |
| | (4) | Average value | N · | 218 | 221 | 220 | 245 | 256 | 240 | 228 | 219 | 260 |
| | Evalua- | of tap torque | cm | | | | | | | | | |
| | tion of | Maximum value | N · | 309 | 310 | 308 | 355 | 365 | 353 | 325 | 305 | 370 |
| | workability | of tap torque | cm | | | | | | | | | |

TABLE 2

| | | | | | | | | | Comparative |
|---|---|---|---|---|---|---|---|---|---|
| | | | | Example | Example | Example | Example | Example | Example |
| | | | | 9 | 10 | 11 | 12 | 13 | 2 |
| Composition | Component | 2-Phenoxyethanol | % by | 3.50 | 3.50 | 3.50 | 3.50 | 3.50 | 0.50 |
| of water- | (A) | | mass | | | | | | |
| soluble | Component | Amine (b-1) | % by | 0.80 | | 1.70 | 0.80 | 0.80 | 1.70 |
| metalworking | (B) | | mass | | | | | | |
| oil | | Amine (b-2) | % by | 1.10 | 1.70 | | 1.10 | 1.10 | |
| | | | mass | | | | | | |
| | | Amine (b-3) | % by | 3.40 | 4.10 | 3.40 | 3.40 | 3.40 | 3.40 |
| | | | mass | | | | | | |
| | | Amine (b-4) | % by | 5.20 | 5.00 | 5.00 | 5.20 | 5.20 | 5.00 |
| | | | mass | | | | | | |
| | | Amine (b-5) | % by | 7.00 | 7.00 | 7.00 | 7.00 | 7.00 | 7.00 |
| | | | mass | | | | | | |
| | Component | Fatty acid (c-2) | % by | 19.60 | 19.60 | 19.60 | 19.60 | 19.60 | 19.60 |
| | (C) | | mass | | | | | | |
| | Component | Nonionic surfactant | % by | 1.00 | 1.00 | 1.00 | 1.00 | 1.00 | 1.00 |
| | (D) | | mass | | | | | | |
| | Component | Paraffinic mineral oil | % by | 20.10 | 19.80 | 20.50 | 20.10 | 20.10 | 23.50 |
| | (E) | | mass | | | | | | |
| | Component | Water | % by | 30.55 | 30.55 | 30.55 | 27.55 | 27.55 | 30.55 |
| | (F) | | mass | | | | | | |
| | Other | Anionic surfactant (1) | % by | 1.00 | 1.00 | 1.00 | 1.00 | 1.00 | 1.00 |
| | components | | mass | | | | | | |
| | | Anionic surfactant (2) | % by | 0.50 | 0.50 | 0.50 | 0.50 | 0.50 | 0.50 |
| | | | mass | | | | | | |
| | | Metal deactivator | % by | 1.00 | 1.00 | 1.00 | 1.00 | 1.00 | 1.00 |
| | | | mass | | | | | | |
| | | Emulsifying aid | % by | 5.00 | 5.00 | 5.00 | 5.00 | 5.00 | 5.00 |
| | | | mass | | | | | | |
| | | Antibacterial agent | % by | 0.20 | 0.20 | 0.20 | 0.20 | 0.20 | 0.20 |
| | | | mass | | | | | | |
| | | Antibacterial agent | % by | 0.05 | 0.05 | 0.05 | 0.05 | 0.05 | 0.05 |
| | | | mass | | | | | | |
| | Petroleum | Na sulfonate | % by | | | | 3.00 | | |
| | sulfonate | | mass | | | | | | |
| | | Ca sulfonate | % by | | | | | 3.00 | |
| | | | mass | | | | | | |
| | Total | | % by | 100.00 | 100.00 | 100.00 | 100.00 | 100.00 | 100.00 |
| | | | mass | | | | | | |
| | Component (A)/Component (B) | | — | 0.20 | 0.20 | 0.20 | 0.20 | 0.20 | 0.03 |
| | Component (A)/Component (C) | | — | 0.18 | 0.18 | 0.18 | 0.18 | 0.18 | 0.03 |
| | Component (A)/Component (D) | | — | 3.50 | 3.50 | 3.50 | 3.50 | 3.50 | 0.50 |
| | Component (B)/Component (C) | | — | 0.89 | 0.91 | 0.87 | 0.89 | 0.89 | 0.87 |
| Properties | Acid value of water-soluble metalworking | | mgKOH/g | 34.4 | 34.1 | 34.2 | 34.6 | 34.8 | 34.4 |
| | oil | | | | | | | | |
| | Base value of water-soluble metalworking | | mgKOH/g | 60.6 | 60.4 | 60.3 | 60.7 | 61.1 | 60.5 |
| | oil | | | | | | | | |
| | Base value/acid value | | mgKOH/g | 1.8 | 1.8 | 1.8 | 1.8 | 1.8 | 1.8 |
| Evaluation | (1) Classification of oil type | | — | S | S | S | S | S | S |
| item | (2) Evaluation of stock solution stability | | — | A | A | A | A | A | F |
| | (3) Evaluation of graphite dispersibility | | — | A | A | A | A | A | F |
| | (4) | Average value of tap | N · cm | 252 | 254 | 250 | 279 | 284 | 284 |
| | Evaluation of | torque | | | | | | | |
| | workability | Maximum value of tap | N · cm | 366 | 368 | 360 | 405 | 410 | 408 |
| | | torque | | | | | | | |

From Tables 1 and 2, the water-soluble metalworking oils of Examples 1 to 13, irrespective of being an emulsion type or a soluble type, had good stock solution stability, and good graphite dispersibility when diluted to form metalworking fluids. On the other hand, the water-soluble metalworking oils of Comparative Examples 1 and 2 were inferior with respect to both stock solution stability and graphite dispersibility.

1. A water-soluble metalworking oil, comprising:
(A) 2-phenoxyethanol in 0.7% by mass or more based on total water-soluble metalworking oil mass.

2. The water-soluble metalworking oil of claim 1, wherein a content of petroleum sulfonate is less than 10 parts by mass, based on 100 parts by mass of the 2-phenoxyethanol (A).

3. The water-soluble metalworking oil of claim 1, wherein the 2-phenoxyethanol (A) is present in a range of from 0.7 to less than 5.0% by mass, based on the total water-soluble metalworking oil mass.

4. The water-soluble metalworking oil of claim 1, further comprising:
an amine compound (B).

5. The water-soluble metalworking oil of claim 1, further comprising:
a fatty acid (C).

6. The water-soluble metalworking oil of claim 1, further comprising:
a nonionic surfactant (D).

7. The water-soluble metalworking oil of claim 1, further comprising:
a base oil (E).

8. The water-soluble metalworking oil of claim 1, further comprising:
water (F).

9. The water-soluble metalworking oil of claim 1, which is an emulsion-type oil classified as A1 as stipulated in JIS K 2241:2017.

10. The water-soluble metalworking oil of claim 1, which is a soluble-type oil classified as A2 as stipulated in JIS K 2241:2017.

11. A metalworking fluid, obtained by blending the water-soluble metalworking oil of claim 1 with dilution water.

12. A metalworking method, comprising:
processing a workpiece comprising metal by application of the metalworking fluid of claim 11.

13. The water-soluble metalworking oil of claim 1, further comprising:
an amine compound (B); and
a fatty acid (C).

14. The water-soluble metalworking oil of claim 1, further comprising:
an amine compound (B); and
a nonionic surfactant (D).

15. The water-soluble metalworking oil of claim 1, further comprising:
an amine compound (B); and
a base oil (E).

16. The water-soluble metalworking oil of claim 1, further comprising:
an amine compound (B); and
water (F).

17. The water-soluble metalworking oil of claim 1, further comprising:
an amine compound (B);
a fatty acid (C); and
a nonionic surfactant (D).

18. The water-soluble metalworking oil of claim 1, further comprising:
an amine compound (B);
a fatty acid (C);
a nonionic surfactant (D); and
a base oil (E).
